(19) United States
(12) Patent Application Publication
(10) Pub. No.: US 2006/0055689 A1
(43) Pub. Date: Mar. 16, 2006

(54) Display device having a fastening mechanism for preventing tilting of a port-holding back plate from a base member

(75) Inventors: Yung-Chuan Tseng, Chu-Nan (TW); Lin Chang Shing, Chu-Nan (TW)

Correspondence Address: BRUCE H. TROXELL, SUITE 1404, 5205 LEESBURG PIKE, FALLS CHURCH, VA, 22041, US

(73) Assignee: Coretronic Corporation

(21) Appl. No.: 11/143,597

(22) Filed: Jun. 3, 2005

(30) Foreign Application Priority Data
Sep. 10, 2004 (TW) 93127572

(51) Int. Cl. G09G 5/00

(52) U.S. Cl. 345/204

(57) ABSTRACT

A display device includes a base member, an outer casing disposed above for covering the base member and defining a rear opening for access to the base member, and a back plate fastened to the base member via a fastening mechanism so that the back plate extends upwardly from the base member to cover the rear opening. The fastening mechanism includes two protrusions extending and engaging the peripheries confining the open-ended slots formed through the lateral sides of the base member and the back plate to prevent tilting of the back plate from the base member.

### FIELD OF THE INVENTION

The present invention relates to a display device, more particularly to a fastening mechanism of the display device.

### BACKGROUND OF THE INVENTION

Referring to FIG. 1, a conventional display device is shown to include a base member 8 having a rear mounting flap formed with a plurality of fixing holes 802, an outer casing (not shown in the figure) covering the base member 8 and defining a rear opening for access to the base member 8, and a back plate 4 disposed on the outer casing for shielding the rear opening. The back plate 4 has a plurality of positioning stems 404 extending inwardly into the fixing holes 802 in the base member 8 such that the former extends upwardly from the latter to cover the rear opening of the outer casing. The back plate 4 further has a plurality of connecting ports 402 exposed externally for establishing electrical communication with the peripheral devices, such as CD or DVD player. The connecting ports 402 include ports for receiving AV terminals, S terminals, connecting ends of coaxial cable connectors and the like. A printed circuit board (not shown) is disposed within the base member 8 and is provided with an electrical connector 6 for connecting with the connecting ports 402 of the back plate 4. In order to strengthen the engagement between the back plate 4 and the base member 8, several fastener screws (not shown) are inserted through the fixing holes 802 and are secured the base member 8.

Note that engagement between the base member 8 and the back plate 4 in the conventional display device is relatively weak since the positioning stems 404 (or the fastener screws) are connected to the base member 8 in a point-to-point manner. The back plate 4 is therefore susceptible to tilt from the base member 8 due to its weight, thereby resulting in improper electrical communication between the connecting ports 402 and the electrical connector 6. Fastening of extra screws at other position rather than the fixing holes 802 can compensate the tilting error but may lead to additional expense and unnecessary extra work, thereby causing inconvenience to the manufacturers or the users.

### SUMMARY OF THE INVENTION

The object of the present invention is to provide a display device having a fastening mechanism of simple structure to prevent tilting of the port-holding back plate from the base member, thereby eliminating the disadvantages of the conventional display device.

A display device of the present invention includes: a base member; an outer casing disposed above and covering the base member and having and a rear portion defining a rear opening for access to the base member, the base member having opposite front and rear ends and left and right lateral sides interconnecting the front and rear ends; a back plate formed with a plurality of ports for connection with peripheral devices being disposed on the rear portion of the casing for covering the rear opening, the back plate having left and right lateral sides; and a fastening mechanism disposed between and fastening the rear plate to the base member in such a manner that the left and right lateral sides of the rear plate and the base member are overlapped with each other and that the rear plate extends upwardly from the base member to cover the rear opening. The fastening mechanism includes: a pair of first protrusions projecting transversely from the left and right lateral sides of the base member, a pair of open-ended first retaining slots disposed respectively rearward of the first protrusions and extending inwardly from the rear distal end toward the front end of the left and right lateral sides of the base member, a pair of second protrusions projecting transversely from the left and right lateral sides of the back plate and engaging the peripheries confining the first retaining slots in the base member, and a pair of open-ended second retaining slots disposed respectively frontward of the second protrusions and being formed in the left and right lateral sides of the back plate, the first protrusions of the base member engaging the peripheries confining the second retaining slots in the back plate to prevent tilting of the back plate with respect to the base member.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is an exploded view of a conventional display device with an outer casing removed therefrom;

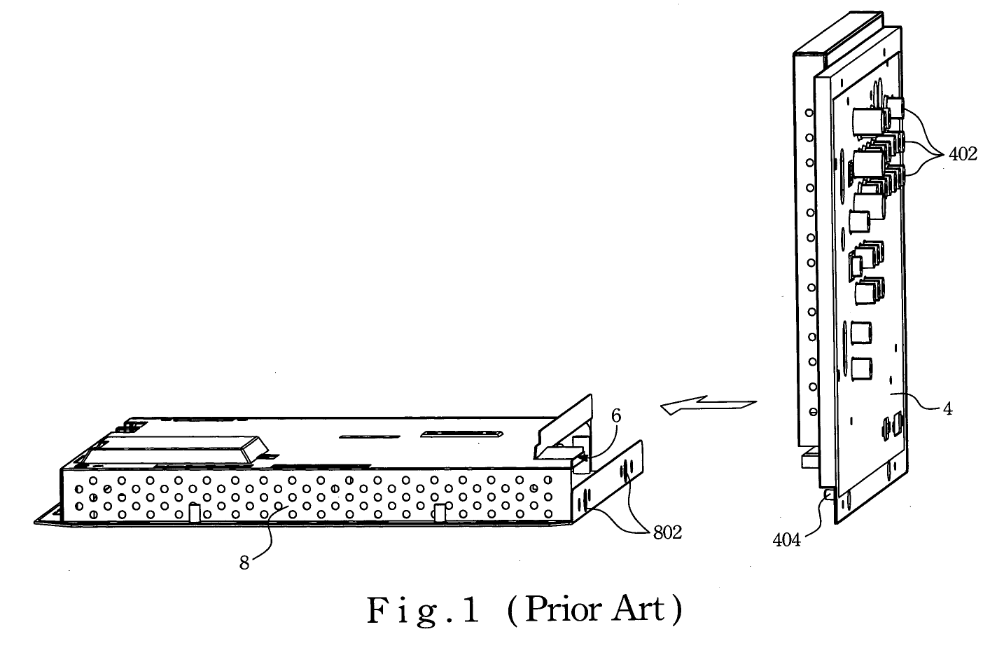

FIG. 2 is a perspective rear view of the preferred embodiment of a display device according to the present invention; and

FIG. 3 is a perspective and exploded view of the display device of the present invention with the outer casing removed therefrom.

### DETAILED DESCCRIPTION OF THE PREFERRED EMBODIMENT

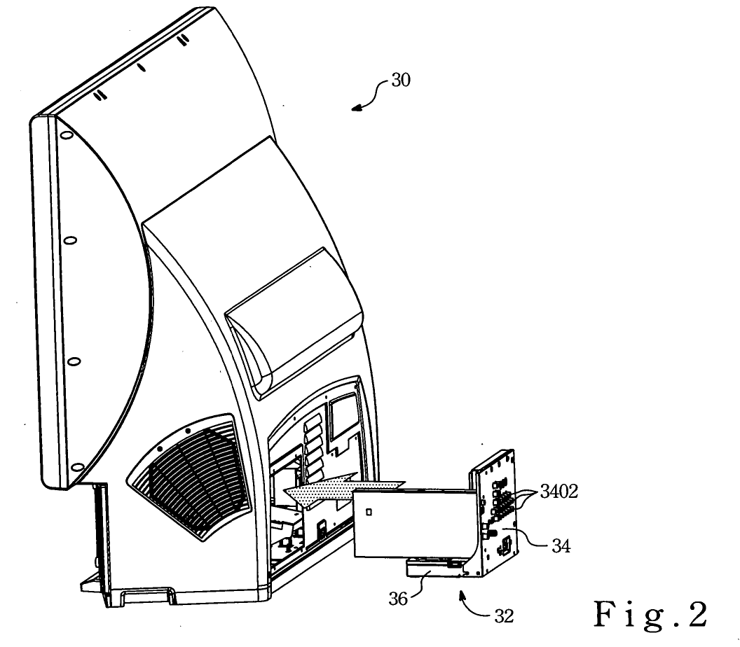

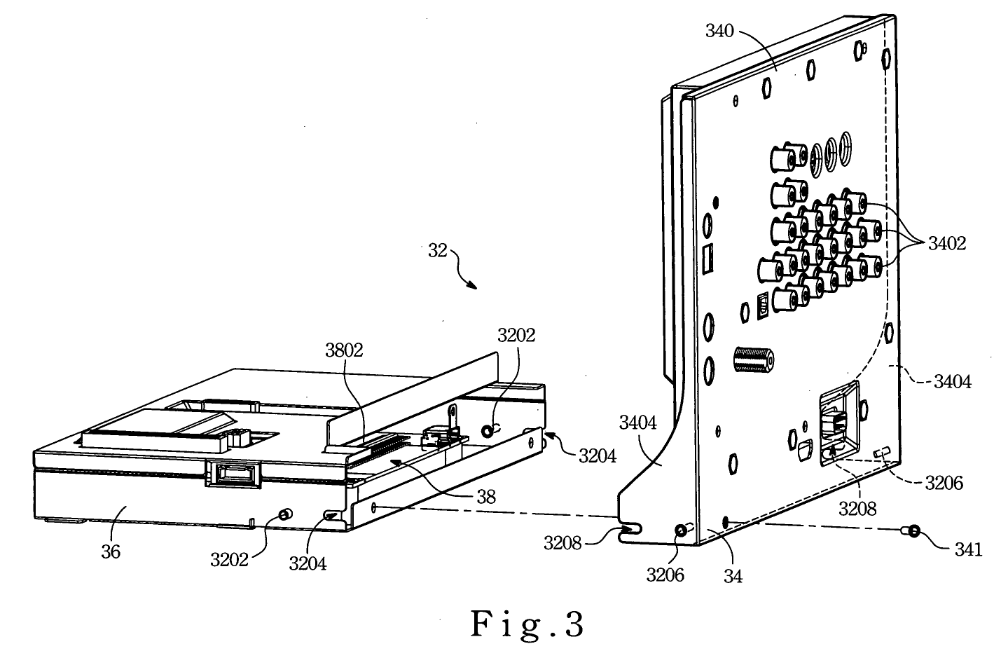

Referring to FIGS. 2 and 3, the preferred embodiment of a display device of the present invention is shown to include a base member 36, an outer casing 30, a port-holding back plate 34, and a fastening mechanism 32.

As illustrated, the outer casing 30 is disposed above and covering the base member 36 to define a rear opening for access to the base member 36. The outer casing 30 is generally made from plastic material in order to reduce the weight thereof. The port-holding back plate 34 is fastened to the base member 36 via the fastening mechanism 32 in such a manner that the back plate 34 extends vertically from the base member 32 so as to cover the rear opening of the outer casing 30. The back plate 34 is formed with a plurality connecting ports 3402 for connection with peripheral devices, such as tape recording-and-reproducing apparatus or DVD player. The connecting ports 3402 including AV ports or S-video ports for receiving connecting ends of AV cable connector or co-axial cable connector are exposed from the outer side surface 340 of the back plate 34. The back plate 34 further has left and right side plates 3404 that extend frontward from the bottom end and that overlap with the left and right side plates of the base member 36 once the back plate 34 is fastened to the base member 36 via the fastening mechanism 32.

The base member 36 is made from metal and preferably is a hollow body, in which a printed circuit board 38 and a plurality of electrical components are disposed therein. The hollow body has front and rear ends, and two left and right side plates interconnecting the front and rear ends. The printed circuit board 38 is formed with an electrical connector 3802 for establishing an electrical communication with the connecting ports 3402 of the back plate 34.

The fastening mechanism 32 includes a pair of first protrusions 3202, a pair of open-ended first retaining slots 3204, a pair of second protrusions 3206, a pair of open-ended second retaining slots 3208, and a plurality of reinforcing screws 341. The first protrusions 3202 project transversely from the outer side surfaces of the left and right side plates of the base member 36. The first retaining slots 3204 are disposed respectively rearward of the first protrusions 3202, and extend inwardly from the rear distal end toward the front end of the left and right side plates of the base member 36. The second protrusions 3206 project transversely from inner side surfaces of the left and right side plates 3404 of the back plate 34 to engage the peripheries confining the first retaining slots 3204 in the base member 36. The second retaining slots 3208 are formed in the left and right side plates 3404 of the back plate 34, and are disposed respectively frontward of the second protrusions 3206 in such a manner that after assembly the first protrusions 3202 of the base member 36 engage the peripheries confining the second slots 3208 in the back plate 34 to prevent tilting of the back plate 34 with respect to the base member 36. In order to prevent untimely disengagement of the back plate 34 from the base member 36, the reinforcing screws 341 can be inserted through the back plate 34 and are threadedly fastened to the base member 36.

As regard to construction of other components that make up the display device, such as a flat plasma TV set or a rear projection television, is not relevant feature of the present invention and its detailed disclosure thereof is omitted herein for the sake of brevity.

It is noted that once the fastening mechanism 32 of the present invention is used in the display device, the assembler in the mass production line requires only a relatively small amount of attention to couple the back plate 34 with the base member 36 since the slots 3204, 3208 are generally aligned with the protrusions 3202, 3206. In addition, the back plate 34 will not tilt from the base member 36 since the entire weight of the back plate 34 are equally distributed along the protrusions 3202, 3206 and the peripheries confining the slots 3204, 3208. Utility of the reinforcing screws 341 provides additional engagement between the base member 36 and the back plate 34.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A display device comprising:
a base member;
an outer casing disposed above and covering said base member, said outer casing having a rear portion defining a rear opening for access to said base member, said base member having opposite front and rear ends and left and right lateral sides interconnecting said front and rear ends;
a back plate with a plurality of ports for connection with peripheral devices being disposed on said rear portion of said casing for covering said rear opening, said back plate having left and right lateral sides; and
a fastening mechanism disposed between said rear plate and said base member, said fastening mechanism fastening said rear plate to said base member, said left and right lateral sides of said rear plate and said base member being overlapped with each other, said rear plate extending upwardly from said base member to cover said rear opening, said fastening mechanism including
a pair of first protrusions projecting transversely from said left and right lateral sides of said base member,
a pair of open-ended first retaining slots disposed respectively rearward of said first protrusions and extending inwardly from said rear distal end toward said front end of said left and right lateral sides of said of said base member,
a pair of second protrusions projecting transversely from said left and right lateral sides of said back plate and engaging the peripheries confining said first retaining slots in said base member, and
a pair of open-ended second retaining slots disposed respectively frontward of said second protrusions and being formed in said left and right lateral sides of said back plate, said first protrusions of said base member engaging the peripheries confining said second slots in said back plate to prevent tilting of said back plate with respect to said base member.

2. The display device according to claim 1, wherein said base member is a hollow body having left and right side plates respectively defining said left and right lateral sides, said first protrusions being formed on outer surfaces of said left and right side plates, said back plate having left and right side plates extending forwardly therefrom and respectively defining said left and right lateral sides thereof, said second protrusions being formed on inner surfaces of said left and right side plates of said back plate.

3. The display device according to claim 2, wherein the display device is a rear projection display device including a printed circuit board disposed in said hollow body.

4. The display device according to claim 3, further comprising an electrical connector mounted on said printed circuit board for establishing electrical communication with said port of said back plate.

5. The display device according to claim 1, further comprising a plurality of reinforcing screws extending through said back plate and threadedly engaging said base member.
